(19) United States
(12) Patent Application Publication
(10) Pub. No.: US 2015/0010742 A1
(43) Pub. Date: Jan. 8, 2015

(54) WINDOW FOR DISPLAY DEVICE AND DISPLAY DEVICE INCLUDING THE WINDOW PANEL

(71) Applicant: Samsung Display Co., Ltd., Yongin-City (KR)

(72) Inventors: Sang-Woo HAN, Yongin-City (KR); Kwan-Young HAN, Yongin-City (KR); Hyoung-Suk ROH, Yongin-City (KR); Jeong-Ho HWANG, Yongin-City (KR); Jee-Seok OH, Yongin-City (KR); Ju-Suk OH, Yongin-City (KR)

(73) Assignee: Samsung Display Co., Ltd., Yongin-City (KR)

(21) Appl. No.: 14/193,224

(22) Filed: Feb. 28, 2014

(30) Foreign Application Priority Data
Jul. 2, 2013 (KR) 10-2013-0077374

(51) Int. Cl. B32B 27/08

(52) U.S. Cl. CPC B32B 27/08
USPC 428/215; 428/412; 428/520; 428/335; 428/339; 428/220

(57) ABSTRACT

A window for a display device includes a polymer resin layer, and a light transmittance film positioned on at least one side of the polymer resin layer, wherein the light transmittance film layer includes a first plastic substrate, a second plastic substrate, and a buffer layer positioned between the first plastic substrate and the second plastic substrate, and a display device including the same.

### RELATED APPLICATIONS

This application claims priority to and the benefit of Korean Patent Application No. 10-2013-0077374 filed in the Korean Intellectual Property Office on Jul. 2, 2013, the entire contents of which are incorporated herein by reference.

### BACKGROUND

1. Field

A window for a display device and a display device including the same are disclosed.

2. Description of the Related Art

Current display devices include a liquid crystal display (LCD), a plasma display panel (PDP), an organic light emitting diode display (OLED), a field effect display (FED), an electrophoretic display device, and the like.

Such display devices include a display module displaying an image and a window protecting the display module.

The window may be made of glass. However, because the glass may be easily broken by an external impact, when glass is used as a window in a portable device such as a mobile phone, the window may be easily damaged. Therefore, a window made of a plastic material instead of the glass has recently been researched.

However, because a window made of a plastic material in general has a structure in which different plastic substrates are stacked, the plastic substrates have different properties, and may deform appearance of the window. This appearance deformation may more easily occur in a window that is not flat (i.e., a three-dimensional window), for example, a bent type window and the like.

### SUMMARY

A window for a display device that maintains optical properties while preventing appearance deformation is provided.

A display device including the window is also provided.

A window for a display device includes a polymer resin layer, and a light transmittance film positioned on at least one side of the polymer resin layer, wherein the light transmittance film layer includes a first plastic substrate, a second plastic substrate, and a buffer layer positioned between the first plastic substrate and the second plastic substrate.

The buffer layer may include a transparent adhesive.

The transparent adhesive may be OCA (Optically Clear Adhesive), PSA (pressure sensitive adhesive), OCR (Optically Clear Resin), or a combination thereof.

The buffer layer may have a thickness of about 10 μm to about 75 μm.

The first plastic substrate and the second plastic substrate may each independently include a plastic substrate selected from a polyethyleneterephthalate (PET) film, a polycarbonate (PC) film, a polymethylmethacrylate (PMMA) film, a polyimide (PI) film, an ABS film, a polyethersulfone (PES) film, a polycarbonate/polymethylmethacrylate (PC/PMMA) film, or a combination thereof.

The first plastic substrate has a thickness of about 50 μm to about 125 μm and the second plastic substrate may have a thickness of about 50 μm to about 250 μm.

The polymer resin layer may include polycarbonate (PC), a polycarbonate-polymethylmethacrylate (PC-PMMA) blend, a cycloolefin polymer (COP), a copolymer thereof, or a combination thereof.

The polymer resin layer and the first plastic substrate may include the same material.

The polymer resin layer and the first plastic substrate may be in a direct contact with each other.

The first plastic substrate may have a stack structure of two or more layers.

The first plastic substrate may have a double-layered structure, the double-layered structure may include different kinds of plastic substrate from each other, and either one of the plastic substrate of the double-layered structure may include the same material as the polymer resin layer.

The polymer resin layer may have a thickness of about 500 μm to about 1000 μm.

The light transmittance film may further include a hard coating layer positioned on one side of the second plastic substrate.

The hard coating layer may include an organic material, an inorganic material, or an organic/inorganic composite compound.

The hard coating layer may have a thickness of about 10 μm to about 30 μm.

The light transmittance film may include an IML (In Mold Labeling) film.

The window for a display device may have a thickness of about 0.5 mm to about 1.2 mm.

The window for a display device may be obtained by injection-molding the light transmittance film and the polymer resin in a film insert manner.

According to another embodiment, a display device including the window for a display device is provided.

The window for a display device secures a close-contacting force among plastic interfaces and thus, may accomplish excellent reliability and simultaneously satisfy optical properties even when the window is three dimensionally manufactured.

### BRIEF DESCRIPTION OF THE DRAWINGS

FIG. 1 is a cross-sectional view showing a window for a display device according to an example embodiment.

FIG. 2 is a cross-sectional view enlarging a “A” portion of FIG. 1.

FIG. 3 is a cross-sectional view of a display device including a window for the display device.

### DETAILED DESCRIPTION

Hereinafter, example embodiments will be described in detail so that a person skilled in the relevant art would understand. This disclosure may, however, be embodied in many different forms and is not construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element, or intervening elements may also be present. In contrast, when an element is referred to as being “directly on” another element, there are no intervening elements present.

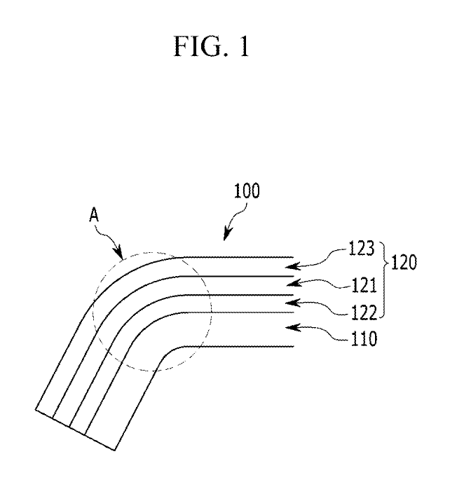

Referring to FIG. 1, a window for a display device according to an example embodiment will be described.

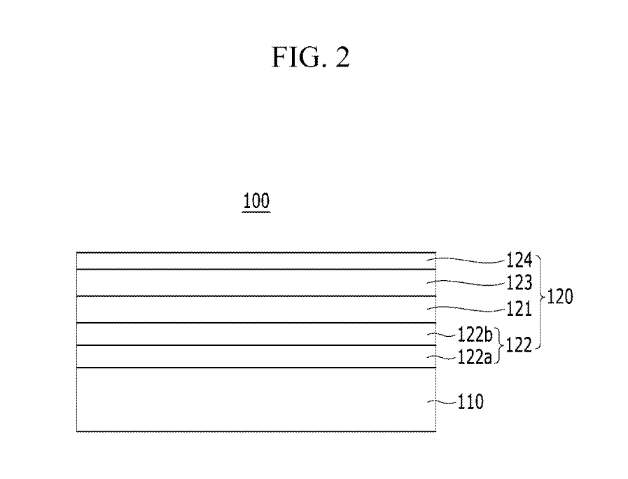

FIG. 1 is a cross-sectional view of a window for a display device according to an example embodiment, and FIG. 2 is a cross-sectional view enlarging a “A” portion of FIG. 1

Referring to FIGS. 1 and 2, a window 100 for a display device according to an example embodiment includes a polymer resin layer 110 and a light transmittance film 120 positioned on one side of the polymer resin layer 110.

The polymer resin layer 110 may be made, for example, of an injection moldable polymer resin.

The polymer resin layer 110 may include, for example, polycarbonate (PC), a polycarbonate-polymethylmethacrylate (PC-PMMA) blend, a cycloolefin polymer (COP), a copolymer thereof or a combination thereof. Herein, “combination” refers to a blend of two or more different compounds, for instance a blend of two or more polymer resins, or a stack of two or more layers of different compounds, for instance, a stack of two or more layers each made with a different polymer resin.

The light transmittance film 120 includes a first plastic substrate 122 and a second plastic substrate 123, and a buffer layer 121 positioned between the first plastic substrate 122 and the second plastic substrate 123.

The first plastic substrate 122 and the second plastic substrate 123 are substrates for a film insert forming process, and may be independently, for example a polyethyleneterephthalate (PET) film, a polycarbonate (PC) film, a polymethylmethacrylate (PMMA) film, a polyimide (PI) film, an ABS film, a polyethersulfone (PES) film, a polycarbonate/polymethylmethacrylate (PC/PMMA) film, or a combination thereof.

The first plastic substrate 122 and the second plastic substrate 123 may include the same material or a different material from each other. For example, the first plastic substrate 122 may include the same material as the buffer layer 121, and the second plastic substrate 123 may include a material having high hardness characteristics. For example, the first plastic substrate 122 may be a polymethylmethacrylate/polycarbonate (PMMA/PC) double layer, and the second plastic substrate 123 may be a polymethylmethacrylate (PMMA) layer, without limitation.

The first plastic substrate 122 and the second plastic substrate 123 may have, for example, each thickness of about 50 μm to about 125 μm and about 50 μm to about 250 μm. The polymer resin layer 110 may have a thickness of about 500 μm to 1000 μm. Within the above range, a sufficient space where a polymer resin flows may be secured during the injection-molding in a film insert manner, and thus impact resistance and surface hardness characteristics of the above-described a polymer resin may be secured and a good appearance may be obtained.

The first plastic substrate 122 may have a stack structure of two or more layers, for example a double-layered or triple-layered structure.

The buffer layer 121 is positioned between the first plastic substrate 122 and the second plastic substrate 123 and bonds them and simultaneously absorbs an impact and may include, for example, a transparent adhesive.

The transparent adhesive may be a transparent polymer resin bonding the plastic substrate 122 and the second plastic substrate 123, for example, OCA (Optically Clear Adhesive), PSA (pressure sensitive adhesive), OCR (Optically Clear Resin), or a combination thereof, but is not limited thereto.

The buffer layer 121 may have, for example a thickness of about 10 μm to about 75 μm.

The buffer layer 121 may absorb a deformation difference when the first and second plastic substrates 122 and 123 have different deformation behaviors. Accordingly, the buffer layer 121 may minimize shape changes of the window 100 for a display device under a reliability condition of a high temperature, high humidity, thermal impact, and the like. In addition, the buffer layer 121 may absorb an impact applied on the second plastic substrate 123 and thus, secure impact resistance of the window 100 for a display device.

The light transmittance film 120 may further include a hard coating layer 124 positioned on one side of the second plastic substrate 123, as shown in FIG. 2.

The hard coating layer 124 may be positioned on the surface of the window 100 for a display device and improves surface hardness. The hard coating layer 124 may include, for example an organic material, an inorganic material or an organic/inorganic composite compound. Herein, the organic material may include, for example an acryl-based compound, an epoxy-based compound, or a combination thereof, the inorganic material may include, for example silica, alumina, or a combination thereof, and the organic/inorganic composite compound may include, for example polysilsesquioxane. The hard coating layer 124 may be a monolayer or a plural layer, and may have a thickness, for example of about 10 μm to about 30 μm.

The polymer resin layer 110 and the first plastic substrate 122 material may include the same material, or a different material from each other.

When the polymer resin layer 110 and the first plastic substrate 122 include different material from each other, the window 100 for a display device may further include a binder layer (not shown) between the polymer resin layer 110 and the first plastic substrate 122.

The substrate 122 may include the same material. For example, when the polymer resin layer 110 includes polymethylmethacrylate (PMMA), the first plastic substrate 122 may also include polymethylmethacrylate (PMMA).

When the polymer resin layer 110 and the first plastic substrate 122 include the same material, a separate joining layer for binding the polymer resin layer 110 and the first plastic substrate 122, for example a binder layer may be omitted.

Therefore, the polymer resin layer 110 and the first plastic substrate 122 may be in a direct contact with each other.

In general, because a binder has a color, for example, yellow, a binder layer may deteriorate the light transmittance and distort a color of the image seen through the window. In addition, the binder layer receives the most stress and may become separated during a reliability evaluation. However, when the binder layer is omitted according to an example embodiment, the window 100 for a display device may be reliably secure as well as have further improved light transmittance.

On the other hand, the first plastic substrate 122 may have a stack structure that includes two or more layers in the stack, for example, a double-layered structure with a first layer 122a and second layer 122b, as shown in FIG. 2. The double-layered structure may include different kinds of plastic substrates in each layer. For example, the first layer 122a of the double layered structure may be polycarbonate (PC), and the second layer 122b may be polymethylmethacrylate (PMMA). Herein, a plastic substrate included in either one of the double layers may be the same as another plastic substrate included in a polymer resin layer 110. In particular, the first layer 122a on a polymer resin layer 110 of the double layer structure may be the same as a plastic substrate included in the polymer resin layer 110.

The light transmittance film 120 may be used in preparation of a window, which is manufactured by an IML (In Mold Labelling) method.

The light transmittance film 120 is illustrated in FIGS. 1 and 2 as being formed on one side of the polymer resin layer 110, but it is not limited thereto, and may be formed on both sides of the polymer resin layer 110.

The window 100 for a display device may be obtained by injection-molding the light transmittance film 120 and the above-described a polymer resin in a film insert manner.

The window 100 for a display device may have a thickness of about 0.5 mm to about 1.2 mm.

The above-described window for a display device may be used in various display devices. The display device may be a liquid crystal display (LCD), an organic light emitting diode (OLED) display, a plasma display, an electric field effect display device, an electrophoresis display device, and the like, but is not limited thereto.

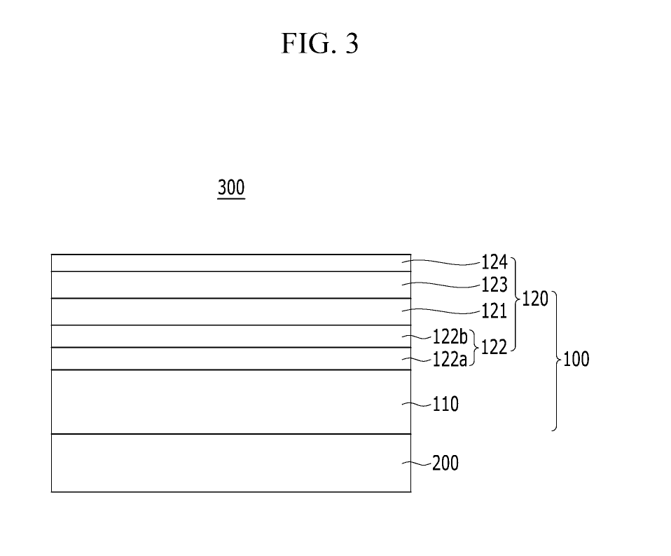

FIG. 3 illustrates an example embodiment of a display device 300 including a window for the display device 100.

The window for a display device 100 may be disposed on a display module 200, wherein the display module 200 may be a liquid crystal display module, an organic light emitting display module, a plasma display module, an electric field effect display module, an electrophoresis display module, and the like.

Hereinafter, the present disclosure is illustrated in more detail with reference to the following examples. However, these examples are for explanatory purposes, and the present disclosure is not limited thereto.

### Manufacture of Window for Display Device

### Example 1

A window for a display device having a polymer resin layer, a first plastic substrate, a second plastic substrate, a buffer layer, and a hard coating layer as provided in the following Table 1 was manufactured in an IML (In Mold Labeling) injection method.

TABLE 1

| | Material | Thickness |
|---|---|---|
| Polymer resin layer | Polycarbonate (PC) | 700 μm |
| First plastic substrate | Upper plate: | 15 μm |
| | polymethylmethacrylate (PMMA) | |
| | Rear plate: | 60 μm |
| | polycarbonate (PC) | |
| Buffer layer | OCA | 50 μm |
| Second plastic | Polymethylmethacrylate (PMMA) | 200 μm |
| substrate | | |
| Hard coating layer | Acryl-based resin | 30 μm |

### Example 2

A window for a display device having a polymer resin layer, a first plastic substrate, a second plastic substrate, a buffer layer, and a hard coating layer as provided in the following Table 2 was manufactured in an IML (In Mold Labeling) injection method.

TABLE 2

| | Material | Thickness |
|---|---|---|
| Polymer resin layer | Polymethylmethacrylate (PMMA) | 700 μm |
| First plastic substrate | Polymethylmethacrylate (PMMA) | 100 μm |
| Buffer layer | OCA | 50 μm |
| Second plastic | Polymethylmethacrylate (PMMA) | 200 μm |
| substrate | | |
| Hard coating layer | Acryl-based resin | 30 μm |

### Example 3

A window for a display device having a polymer resin layer, a first plastic substrate, a second plastic substrate, a buffer layer, a hard coating layer, and a binder layer as provided in the following Table 3 was manufactured in an IML (In Mold Labeling) method.

TABLE 3

| | Material | Thickness |
|---|---|---|
| Polymer resin layer | Polycarbonate (PC) | 700 μm |
| Binder layer | Polyester | 20 μm |
| First plastic substrate | Polymethylmethacrylate (PMMA) | 100 μm |
| Buffer layer | OCA | 50 μm |
| Second plastic | Polymethylmethacrylate (PMMA) | 150 μm |
| substrate | | |
| Hard coating layer | Acryl-based resin | 30 μm |

### Comparative Example 1

A window for a display device having a polymer resin layer, a first plastic substrate, a second plastic substrate, a hard coating layer, and a binder layer as provided in the following Table 4 was manufactured in an IML (In Mold Labeling) method.

TABLE 4

| | Material | Thickness |
|---|---|---|
| Polymer resin layer | Polycarbonate (PC) | 700 μm |
| Binder layer | Polyester | 20 μm |
| First plastic substrate | Polyethylene terephthalate (PET) | 105 μm |
| Hard coating layer | Acryl-based | 30 μm |

### Evaluation 1

### Appearance Deformation

The windows for a display device according to Examples 1 to 3 and Comparative Example 1 were evaluated regarding appearance deformation such as distortion, excitation, and the like under a reliability condition of a high temperature/high humidity (avowed to stand at about 85° C. and about 85% of humidity for 72 hours). The results are provided in the following Table 5.

TABLE 5

| | Comparative | | | |
|---|---|---|---|---|
| Evaluation | Example 1 | Example 1 | Example 2 | Example 3 |
| Appearance | 0.7 mm | 0.25 mm | 0.2 mm | 0.25 mm |
| deformation | | | | |
| (changes of | | | | |
| planarization) | | | | |

Referring to Table 5, the windows for a display device according to Examples 1 to 3 had a small planarization change compared with the window for a display device according to Comparative Example 1.

### Evaluation 2

### Light Transmittance

The windows for a display device according to Examples 1 to 3 were measured regarding light transmittance by a D65 light source and CM-3600D (Konica Minolta spectrometer). The results are provided in the following Table 6.

TABLE 6

| Evaluation | | Example 1 | Example 2 | Example 3 |
|---|---|---|---|---|
| Light transmittance | | 89.3% | 89.5% | 89.2% |
| Yellow | Initial | 1.05 | 0.85 | 1.3 |
| Index | After reliability | 1.15 | 0.9 | 1.87 |
| YI (D1925 | evaluation (85° C./ | | | |
| reference) | 85% of humidity/72 Hrs) | | | |

Referring to Table 6, the windows for a display device according to Examples 1 to 3 had light transmittance appropriately usable for a display device. In particular, the windows for a display device including no binder layer according to Examples 1 and 2 had higher light transmittance and transparency.

According to example embodiments, deformation of a window for a display device may be minimized by including a buffer layer capable of absorbing a deformation difference when plastic substrates have a different deformation behavior. Accordingly, the window for a display device may be three dimensionally designed to have various shapes.

In addition, reliability, light transmittance, and transparency of a device may be secured by omitting a binder layer between a polymer resin layer and another layer facing the polymer resin layer according to example embodiments.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the disclosure, including the appended claims.

### DESCRIPTION OF SYMBOLS

100: window for a display device
110: polymer resin layer
120: light transmittance film
121: buffer layer
122: first plastic substrate
123: second plastic substrate
124: hard coating layer

What is claimed is:

1. A window for a display device, comprising
a polymer resin layer, and
a light transmittance film positioned on at least one side of the polymer resin layer,
wherein the light transmittance film layer includes a first plastic substrate, a second plastic substrate, and a buffer layer positioned between the first plastic substrate and the second plastic substrate.

2. The window for a display device of claim 1, wherein the buffer layer comprises a transparent adhesive.

3. The window for a display device of claim 2, wherein the transparent adhesive is OCA (Optically Clear Adhesive), PSA (pressure sensitive adhesive), OCR (Optically Clear Resin), or a combination thereof.

4. The window for a display device of claim 1, wherein the buffer layer has a thickness of about 10 μm to about 75 μm.

5. The window for a display device of claim 1, wherein the first plastic substrate and the second plastic substrate each independently comprises a plastic substrate selected from a polyethyleneterephthalate (PET) film, a polycarbonate (PC) film, a polymethylmethacrylate (PMMA) film, a polyimide (PI) film, an ABS film, a polyethersulfone (PES) film, a polycarbonate/polymethylmethacrylate (PC/PMMA) film, or a combination thereof.

6. The window for a display device of claim 1, wherein the first plastic substrate has a thickness of about 50 μm to about 125 μm and the second plastic substrate has a thickness of about 50 μm to about 250 μm.

7. The window for a display device of claim 1, wherein the polymer resin layer comprises polycarbonate (PC), a polycarbonate-polymethylmethacrylate (PC-PMMA) blend, a cycloolefin polymer (COP), a copolymer thereof, or a combination thereof.

8. The window for a display device of claim 1, wherein the polymer resin layer and the first plastic substrate comprises the same material.

9. The window for a display device of claim 8, wherein the polymer resin layer and the first plastic substrate are in a direct contact with each other.

10. The window for a display device of claim 1, which further comprises a binder layer between the polymer resin layer and the first plastic substrate.

11. The window for a display device of claim 1, wherein the first plastic substrate has a stack structure of two or more layers.

12. The window for a display device of claim 11, wherein the first plastic substrate has a double-layered structure, the double-layered structure comprises different kinds of plastic substrate from each other, and either one of the plastic substrate of the double-layered structure comprises the same material as the polymer resin layer.

13. The window for a display device of claim 1, wherein the polymer resin layer has a thickness of about 500 μm to about 1000 μm.

14. The window for a display device of claim 1, wherein the light transmittance film further comprises a hard coating layer positioned on one side of the second plastic substrate.

15. The window for a display device of claim 14, wherein the hard coating layer comprises an organic material, an inorganic material, or an organic/inorganic composite compound.

16. The window for a display device of claim 14, wherein the hard coating layer has a thickness of about 10 μm to about 30 μm.

17. The window for a display device of claim 1, wherein the light transmittance film comprises an IML (In Mold Labeling) film.

18. The window for a display device of claim 1, wherein the window for a display device has a thickness of about 0.5 mm to about 1.2 mm.

19. The window for a display device of claim 1, wherein the window for a display device is obtained by injection-molding the light transmittance film and the polymer resin in a film insert manner.

20. A display device comprising the window for a display device according to claim 1.
